(19) United States
(12) Patent Application Publication
(10) Pub. No.: US 2026/0073228 A1
(43) Pub. Date: Mar. 12, 2026

(54) METHOD AND APPARATUS FOR TRAINING NATURAL LANGUAGE PRE-TRAINED MODEL, DEVICE, AND STORAGE MEDIUM

(71) Applicant: BEIJING LONGZHI DIGITAL TECHNOLOGY CO., LTD., Beijing (CN)

(72) Inventors: Yujian BAO, Beijing (CN); Wenjun ZHANG, Beijing (CN); Zihan YUAN, Beijing (CN)

(73) Assignee: BEIJING LONGZHI DIGITAL TECHNOLOGY CO., LTD., Beijing (CN)

(21) Appl. No.: 19/107,057

(22) PCT Filed: Nov. 2, 2022
(86) PCT No.: PCT/CN2022/129305

§ 371 Date: Feb. 27, 2025

(30) Foreign Application Priority Data
Aug. 30, 2022 (CN) 202211047077.5

(51) Int. Cl. G06N 3/09; G06F 40/242; G06F 40/284; G06F 40/40; G06N 3/045

(52) U.S. Cl. CPC G06N 3/09; G06F 40/242; G06F 40/284; G06F 40/40; G06N 3/045

(57) ABSTRACT

A method and apparatus for training a natural language pre-trained model, a device, and a storage medium are provided. The method includes: tokenizing a text by using a dictionary, and converting tokens into one-hot codes; inputting the one-hot codes into a token embedding layer, and performing mapping by using the token embedding layer to obtain a static token vector corresponding to each token; adding the static token vector, a segment embedding vector, and a position embedding vector to obtain an input vector of each token, and taking the input vector as an input to obtain a dynamic token vector corresponding to each token; calculating similarity between the static token vector and the dynamic token vector, and taking a similarity calculation result as a constraint item; and adjusting an original loss function by using the constraint item, and training the natural language pre-trained model with the adjusted original loss function.

### CROSS REFERENCE TO THE RELATED APPLICATIONS

This application is the national phase entry of International Application No. PCT/CN2022/129305, filed on Nov. 2, 2022, which is based upon and claims priority to Chinese Patent Application No. 202211047077.5, filed on Aug. 30, 2022, the entire contents of which are incorporated herein by reference.

### TECHNICAL FIELD

The present application relates to the field of natural language processing technologies, and in particular, to a method and apparatus for training a natural language pre-trained model, a device, and a storage medium.

### BACKGROUND

A current mainstream bidirectional encoder representation from transformers (BERT)-structure-based self-attention pre-trained model predicts masked tokens after tokens in an input text are masked randomly, such that obtained token vectors take a context into consideration. Currently, performances of most of the pre-trained models improved based on a BERT are improved by increasing language materials, enlarging scales of the models, or the like.

In a training process of a natural language pre-trained model, meanings of one token in different contexts are different, but the meanings of the token in different contexts are derived from an original meaning of the token, such that the meaning of one token in a certain context is usually inferred from the original meaning of the token. However, an influence of the original meaning of the token on the token vector obtained after training is not fully considered in a design of the current BERT-based pre-trained model, and the influence that the original meaning of the token (static token meaning) may not only increase a training time of the model, but also reduce a precision performance of the model is not considered sufficiently.

In view of the problem in the prior art, it is urgently needed to provide a natural language pre-trained model training solution which can fully consider the original meaning of the token while considering a context meaning of the token, thereby improving a training effect of the natural language pre-trained model to allow the model to obtain better precision and generalization performance.

### SUMMARY

In view of this, embodiments of the present application provide a method and apparatus for training a natural language pre-trained model, a device, and a storage medium, so as to solve the problem in the prior art that an original meaning of a token cannot be fully considered, such that a training effect of the natural language pre-trained model is reduced, and the model cannot obtain better precision and generalization performance.

In a first aspect of the embodiments of the present application, there is provided a method for training a natural language pre-trained model, including: tokenizing a text by using a dictionary of a natural language pre-trained model, and converting tokens in the text into corresponding one-hot codes; inputting the one-hot codes corresponding to the text into a token embedding layer, and performing mapping by using the token embedding layer to obtain a static token vector corresponding to each token; adding the static token vector, a segment embedding vector, and a position embedding vector corresponding to each token to obtain a corresponding input vector of each token, and taking the input vector as an input of the natural language pre-trained model to obtain a dynamic token vector corresponding to each token; calculating similarity between the static token vector and the dynamic token vector corresponding to each token, and taking a similarity calculation result as a constraint item; and adjusting an original loss function of the natural language pre-trained model by using the constraint item, and training the natural language pre-trained model with the adjusted original loss function.

In a second aspect of the embodiments of the present application, there is provided an apparatus for training a natural language pre-trained model, including: a converting module configured to tokenize a text by using a dictionary of a natural language pre-trained model, and convert tokens in the text into corresponding one-hot codes; a mapping module configured to input the one-hot codes corresponding to the text into a token embedding layer, and perform mapping by using the token embedding layer to obtain a static token vector corresponding to each token; an input module configured to add the static token vector, a segment embedding vector, and a position embedding vector corresponding to each token to obtain a corresponding input vector of each token, and take the input vector as an input of the natural language pre-trained model to obtain a dynamic token vector corresponding to each token; a calculating module configured to calculate similarity between the static token vector and the dynamic token vector corresponding to each token, and take a similarity calculation result as a constraint item; and an adjusting module configured to adjust an original loss function of the natural language pre-trained model by using the constraint item, and train the natural language pre-trained model with the adjusted original loss function.

In a third aspect of the embodiments of the present application, there is provided an electronic device, including a memory, a processor and a computer program stored on the memory and runnable on the processor, wherein the processor, when executing the program, implements the steps of the above method.

In a fourth aspect of the embodiments of the present application, there is provided a computer-readable storage medium storing a computer program, wherein the computer program, when executed by a processor, implements the steps of the above method.

At least one of the above technical solutions adopted in the embodiments of the present application can achieve the following beneficial effects.

The text is tokenized by using the dictionary of the natural language pre-trained model, and the tokens in the text are converted into the corresponding one-hot codes; the one-hot codes corresponding to the text are input into the token embedding layer, and the mapping is performed by using the token embedding layer to obtain the static token vector corresponding to each token; the static token vector, the segment embedding vector, and the position embedding vector corresponding to each token are added to obtain the corresponding input vector of each token, and the input vector is taken as the input of the natural language pre-trained model to obtain the dynamic token vector corresponding to each token; the similarity between the static token vector and the dynamic token vector corresponding to each token is calculated, and the similarity calculation result is taken as the constraint item; and the original loss function of the natural language pre-trained model is adjusted by using the constraint item, and the natural language pre-trained model with the adjusted original loss function is trained. With the present application, the original meaning of the token can be fully considered while a context meaning of the token is considered, thereby improving the training effect of the natural language pre-trained model to allow the model to obtain the better precision and generalization performance.

### BRIEF DESCRIPTION OF THE DRAWINGS

In order to more clearly illustrate the technical solutions in the embodiments of the present application, the accompanying drawings used in the description of the embodiments or the prior art will be briefly introduced below. It is apparent that, the accompanying drawings in the following description are only some embodiments of the present application, and other drawings can be obtained by those of ordinary skill in the art from the provided drawings without creative efforts.

FIG. 1 is a schematic flowchart of a method for training a natural language pre-trained model according to an embodiment of the present application;

FIG. 2 is a schematic diagram of a calculation process of a constraint item in a practical application scenario in an embodiment of the present application;

FIG. 3 is a schematic structural diagram of an apparatus for training a natural language pre-trained model according to an embodiment of the present application; and

FIG. 4 is a schematic structural diagram of an electronic device according to an embodiment of the present application.

### DETAILED DESCRIPTION OF THE EMBODIMENTS

In the following description, for the purpose of illustration instead of limitation, specific details such as a particular system structure and a technology are provided to make the embodiments of the present application understood thoroughly. However, it should be understood by those skilled in the art that the present application can also be implemented in other embodiments without the specific details. In other cases, detailed description of well-known systems, apparatuses, circuits and methods is omitted, so that the present application is described without being impeded by unnecessary details.

In recent years, with a continuous development of artificial intelligence and natural language technologies, natural language pre-trained models are widely applied to various fields to solve natural language processing (NLP) tasks in actual scenarios, such as text classification, speech recognition, or the like. The current mainstream BERT (bidirectional encoder representation from transformers)-structure-based self-attention pre-trained model predicts masked tokens after tokens in an input text are masked randomly, such that obtained token vectors take a context into consideration. Currently, performances of most of the pre-trained models improved based on a BERT are improved by increasing language materials, enlarging scales of the models, or the like.

In the current field of natural language processing, in the mainstream BERT-based pre-trained model, training is performed using the context of one token to obtain a dynamic token vector of the token, which considers different meanings of the token in different contexts, but gives less consideration to an inherent meaning of the token. In a natural language, the meanings of one token in different contexts are different, but the meanings of the token in different contexts are derived from the original meaning of the token, such that the meaning of one token in a certain context is usually inferred from the original meaning of the token. However, an influence of the original meaning of the token on the token vector obtained after training is not fully considered in a design of the current BERT-based pre-trained model, and the influence that the original meaning of the token (static token meaning) may not only increase a training time of the model, but also reduce a precision performance of the model is not considered sufficiently. Therefore, an existing method for training the natural language pre-trained model has the problems of a long model training time, a poor training effect and low model precision and generalization performance.

In view of the problems in the prior art, the present application provides an improved method for training a natural language pre-trained model, in which before the natural language pre-trained model is trained, a static token vector and the dynamic token vector corresponding to each token are obtained, and similarity between the dynamic token vector obtained by considering the context and the static token vector of the token is calculated to close expressions of the two token vectors in a semantic space. A similarity calculation result is used as a constraint item to adjust an original loss function of the natural language pre-trained model, and the natural language pre-trained model with the adjusted original loss function is trained, such that the trained model can fully consider the original meaning of the token while considering the context, thus improving the effect of the natural language pre-trained model to allow the model to have better precision and generalization performance.

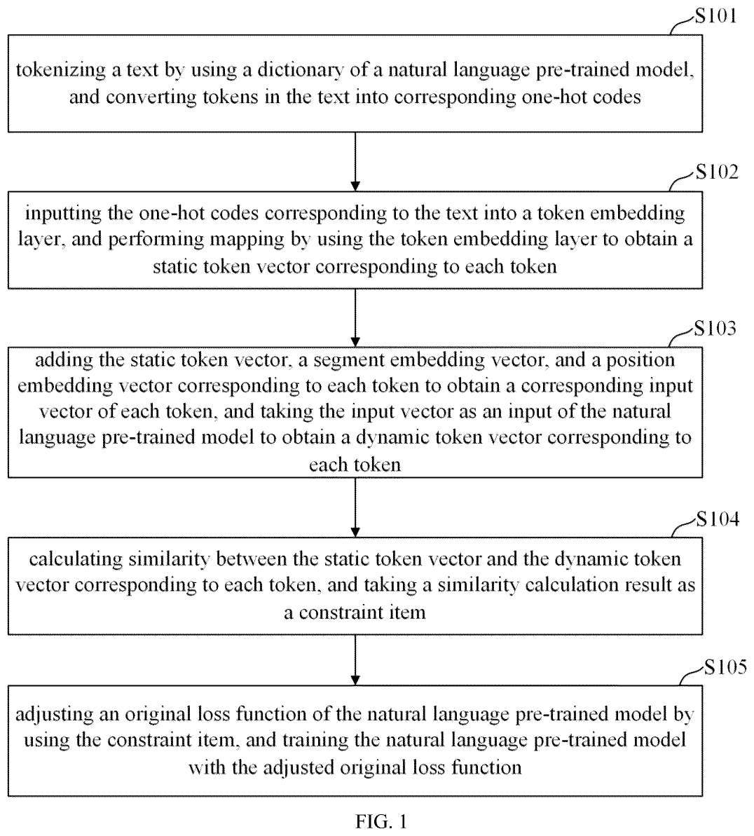

FIG. 1 is a schematic flowchart of a method for training a natural language pre-trained model according to an embodiment of the present application. The method for training a natural language pre-trained model of FIG. 1 may be performed by a server. As shown in FIG. 1, the method for training a natural language pre-trained model may specifically include:
S101: tokenizing a text by using a dictionary of a natural language pre-trained model, and converting tokens in the text into corresponding one-hot codes;
S102: inputting the one-hot codes corresponding to the text into a token embedding layer, and performing mapping by using the token embedding layer to obtain a static token vector corresponding to each token;
S103: adding the static token vector, a segment embedding vector, and a position embedding vector corresponding to each token to obtain a corresponding input vector of each token, and taking the input vector as an input of the natural language pre-trained model to obtain a dynamic token vector corresponding to each token;
S104: calculating similarity between the static token vector and the dynamic token vector corresponding to each token, and taking a similarity calculation result as a constraint item; and
S105: adjusting an original loss function of the natural language pre-trained model by using the constraint item, and training the natural language pre-trained model with the adjusted original loss function.

Specifically, one-hot encoding, also known as one-bit valid encoding, of the embodiments of the present application has the principle that an N-bit state register is used to encode N states, each state has its own independent register bit, and only one bit is valid at any time. In the embodiment of the present application, each token in the text is converted into the corresponding one-hot code, such that the whole text corresponds to a series of one-hot codes (the one-hot codes are arranged according to a sequence of the tokens).

Further, in the embodiment of the present application, different token vectors obtained using one token in different contexts are referred to as the dynamic token vectors, and token vectors obtained without considering the context of the token are referred to as the static token vectors of the token. The dynamic token vectors can characterize the meanings of the token in different contexts, and the static token vector can characterize the original meaning of the token.

It should be noted that, the following embodiments of the present application are described in detail with a BERT-based self-attention pre-trained model (abbreviated as BERT pre-trained model or BERT model) as the natural language pre-trained model, but it should be understood that the natural language pre-trained model in the embodiments of the present application is not limited to the BERT pre-trained model, any model that can be applied in the natural language processing task is applicable to the present application, and a type of the natural language pre-trained model does not constitute a limitation on a technical solution of the present application.

In some embodiments, the inputting the one-hot codes corresponding to the text into a token embedding layer, and performing mapping by using the token embedding layer to obtain a static token vector corresponding to each token includes: generating a series of one-hot codes corresponding to the text based on the one-hot codes corresponding to the tokens in the text, inputting the series of one-hot codes into the token embedding layer, mapping the series of one-hot codes by using the token embedding layer to obtain an original vector representation corresponding to each token, and taking the original vector representation of each token as the static token vector.

Specifically, before the mapping is performed by using the token embedding layer to obtain the static token vector corresponding to each token, the input text is tokenized according to the dictionary of the natural language pre-trained model (BERT pre-trained model) and then converted into the one-hot codes corresponding to the tokens using a token list of the BERT pre-trained model.

Further, after the one-hot code corresponding to each token is obtained, according to the one-hot codes corresponding to the tokens and the sequence of the tokens in the text, the series of one-hot codes corresponding to the text are generated, the series of one-hot codes are input into the token embedding layer of the BERT pre-trained model, and the original vector representation corresponding to each token, i.e., the static token vector corresponding to each token is obtained through mapping. The static token vector can express the original meaning of the token.

In some embodiments, the adding the static token vector, a segment embedding vector, and a position embedding vector corresponding to each token to obtain a corresponding input vector of each token, and taking the input vector as an input of the natural language pre-trained model to obtain a dynamic token vector corresponding to each token includes: acquiring the segment embedding vector and the position embedding vector corresponding to each token in the text, mapping the static token vector, the segment embedding vector, and the position embedding vector into a same dimensional space, and adding the static token vector, the segment embedding vector, and the position embedding vector in the same dimensional space to obtain the input vector corresponding to each token; and inputting the input vector into the natural language pre-trained model, performing training of a token masking task and a preceding-next sentence task by using the natural language pre-trained model, and outputting the dynamic token vector corresponding to each token in the text.

Specifically, after the mapping is performed by using the token embedding layer to obtain the static token vector corresponding to each token, the static token vector, the segment embedding vector, and the position embedding vector of each token are mapped into the same dimensional space; for example, each vector is mapped into a 768-dimensional space; that is, each vector is mapped into a 768-dimensional vector, and then, the static token vector, the segment embedding vector, and the position embedding vector in a same dimension are added (that is, vector addition) to obtain the input vector corresponding to each token.

Further, the input vector is input into the BERT pre-trained model, the training of the token masking task and the preceding-next sentence task is performed by using the BERT pre-trained model, and finally, the dynamic token vector corresponding to each token in the text is output by the BERT pre-trained model.

The BERT model is a Transformer-based bidirectional encoder representation, and is a pre-trained language characterization model, which emphasizes that, instead of adopting a traditional unidirectional language model or a method of performing shallow-layer splicing on two unidirectional language models for pre-training as before, a new masked language model (MLM) is adopted, so as to generate a deep bidirectional language characterization. The BERT model has a goal of using large-scale unmarked language materials for training to obtain a representation of a text containing rich semantic information (i.e., semantic representation of the text), then fine-tuning the semantic representation of the text in a specific NLP task, and finally applying the representation to the NLP task.

Further, in order to learn semantic information, the BERT official model is pre-trained using two tasks; that is, the following two core tasks are introduced into the pre-training of the BERT model: a randomly and statically masked LM training task and a next sequence prediction task. Since a structure and the training task of the BERT model are not improved and adjusted in the present application, the BERT model will not be described herein in more detail.

In some embodiments, the calculating similarity between the static token vector and the dynamic token vector corresponding to each token, and taking a similarity calculation result as a constraint item includes: calculating a vector inner product of the static token vector and the dynamic token vector of each token, taking the vector inner product as the similarity calculation result of the static token vector and the dynamic token vector, and taking the similarity calculation result as the constraint item constructed based on the static token vector; the static token vector and the dynamic token vector having a same dimension.

Specifically, after the static token vector and the dynamic token vector corresponding to each token are obtained, a constraint condition (i.e., the constraint item) in the training process of the BERT model is determined by calculating the vector similarity between the static token vector and the dynamic token vector. In practical applications, preferably, in the embodiment of the present application, the inner product between the vectors may be adopted to represent the similarity between the vectors, and the greater the vector inner product is, the greater the similarity is.

Further, when the vector inner product is used to measure the similarity between the static token vector and the dynamic token vector, the vector inner product may be calculated using the following formula:

$$R = \frac{1}{N} {{\sum }^{N}}_{i = 0} {Ve}_{i} \cdot {Vt}_{i}$$

wherein R represents the vector inner product, N represents a number of tokens (or characters) in a sentence, i represents a position of the token (or character) in the sentence, Veᵢ represents the static token vector, and Vtᵢ represents the dynamic token vector.

It should be noted that, in the embodiment of the present application, the static token vector (or static character vector) is denoted as Veᵢ, wherein i represents the position of the token or character in the sentence, and generally starts from 0; the dynamic vector corresponding to the token or character obtained after mapping by a multi-layer self-attention neural network (BERT model network) is denoted as Vtᵢ, wherein i is the position of the token or character in the sentence, and generally starts from 0, and the sentence has N tokens or characters. Calculated R is used as the subsequent constraint item which is also called a constraint condition.

In some embodiments, the calculating similarity between the static token vector and the dynamic token vector corresponding to each token, and taking a similarity calculation result as a constraint item includes: calculating cosine similarity or a Manhattan distance between the static token vector and the dynamic token vector of each token, taking the cosine similarity or the Manhattan distance as the similarity calculation result of the static token vector and the dynamic token vector, and taking the similarity calculation result as the constraint item.

Specifically, in the embodiment of the present application, in addition to using the vector inner product to represent the similarity between the vectors, the cosine similarity or Manhattan distance between the vectors is used to represent the similarity; that is, the cosine similarity or Manhattan distance between the static token vector and the dynamic token vector is used as the constraint item. A way of calculating the cosine similarity or Manhattan distance is not described here, and certainly, other vector similarity calculating ways than the cosine similarity or Manhattan distance are also applicable to the present application.

According to the technical solution of the embodiment of the present application, the similarity between the vectors is measured by adopting the vector inner product, cosine similarity, Manhattan distance, or the like in the embodiment of the present application, such that the similarity of the dynamic token vector and the static token vector in the semantic space is improved, and the finally obtained token vector not only fuses context information, but also fully refers to the static meaning of the token.

In some embodiments, the adjusting an original loss function of the natural language pre-trained model by using the constraint item includes adjusting the original loss function using the following formula:

$$loss = ( 1 - α ) \cdot suploss - α \cdot regulation$$

wherein loss represent the adjusted loss unction, sup loss represents the original loss function, α represents a partition coefficient and is used for adjusting model training precision, and regulation represents the constraint item constructed based on the static token vector.

Specifically, after the constraint item based on the static token vector is calculated, the original loss function of the natural language pre-trained model (BERT pre-trained model) in the downstream natural language processing task is adjusted by using the constraint item; that is, the original loss function suploss is adjusted by using the above formula, so as to obtain the adjusted loss function loss.

In practical applications, loss is the modified (i.e., adjusted) loss function, suploss is the original supervised learning loss function (such as a cross entropy loss function), regulation is the constraint item constructed based on the static token (character) vector mentioned above, a is the partition coefficient, is used for adjusting the model training precision, is in an open interval from 0 to 1, and can be empirically between 0.1 and 0.2, and a value thereof is required to be adjusted according to different tasks.

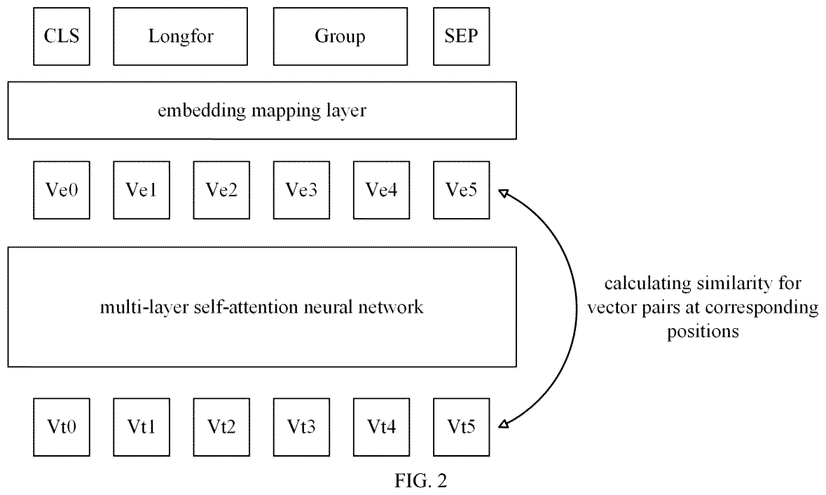

The above details are provided for the complete embodiment of the technical solution of the present application, and the following describes the training process of the natural language pre-trained model in the present application in conjunction with the accompanying drawings and the specific embodiment. FIG. 2 is a schematic diagram of a calculation process of the constraint item in a practical application scenario in the embodiment of the present application, and as shown in FIG. 2, the calculation process of the constraint item in the practical application scenario may specifically include the following content.

In a specific embodiment, it is assumed that for a sentence composed of four original characters “CLS Longfor Group SEP”, each token (or character) is first converted into a corresponding one-hot code, and then, the one-hot codes are mapped into static token vectors by using an embedding mapping layer (i.e., token embedding layer), that is, into static token vectors Ve0 to Ve3 respectively; then, an input vector corresponding to each token is used as an input of a multi-layer self-attention neural network (i.e., BERT model network), a dynamic token vector corresponding to each token is output by the BERT model network, and the dynamic token vectors corresponding to the tokens (or characters) are denoted as Vt0 to Vt3 respectively.

Since the input vector of the token is obtained by adding the static token vector, a segment embedding vector, and a position embedding vector mapped to the same dimension, for example, all the vectors are mapped into 768-dimensional vectors, the static token vectors Ve0 to Ve3 have the same dimension as the dynamic token vectors Vt0 to Vt3; the static token vectors characterize static meanings of the tokens, and the dynamic token vectors are generated using an attention mechanism, such that context information is integrated, and thus, the dynamic token vectors contain dynamic meanings of the tokens.

Then, based on the static token vector and the dynamic token vector of each token, a vector inner product between the static token vector and the dynamic token vector is calculated by using the vector inner product calculation formula in the foregoing embodiment, and the vector inner product is used as the constraint item; an original loss function of a BERT model in a supervised learning natural language processing task is adjusted with the constraint item, and the BERT model with the adjusted loss function is trained, such that the trained BERT model obtains better precision and generalization performance.

According to the technical solution of the embodiment of the present application, the embodiment of the present application at least has the following advantages:
(1) in the present application, in the process of training the BERT-based pre-trained model, the constraint item is calculated based on the static token vector and the dynamic token vector of the token, the original loss function of the BERT pre-trained model is adjusted with the constraint item, and the BERT pre-trained model with the adjusted original loss function is trained, thus shortening a training time of the BERT pre-trained model;
(2) in the application, the similarity between the dynamic token vector and the static token vector of each token in the sentence is improved by introducing the constraint item in the training process of the BERT pre-trained model, thus achieving the aim of shortening a distance between the dynamic token vector and the static token vector in the semantic space;
(3) the present application is suitable for various pre-trained models (including various improved models) similar to the BERT and based on the multi-layer self-attention mechanism, and has a wide application range;
(4) with the model training method according to the present application, after the model in the downstream task is subjected to fine tuning and training, the model can obtain better precision and generalization performance than a model without the solution.

An apparatus according to the embodiments of the present application is described below, and may be configured to perform the method according to the embodiments of the present application. For details not disclosed in the embodiments of the apparatus according to the present application, reference is made to the embodiments of the method according to the present application.

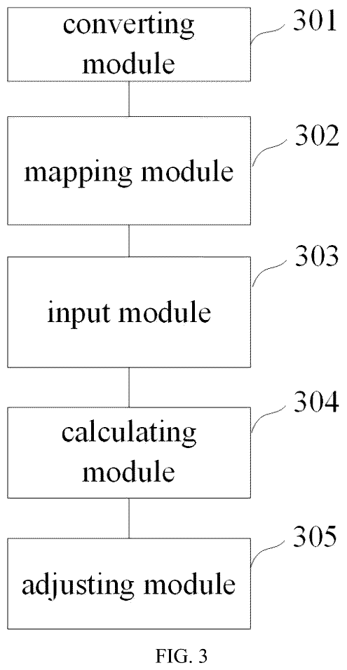

FIG. 3 is a schematic structural diagram of an apparatus for training a natural language pre-trained model according to an embodiment of the present application. As shown in FIG. 3, the apparatus for training a natural language pre-trained model includes:
a converting module 301 configured to tokenize a text by using a dictionary of a natural language pre-trained model, and convert tokens in the text into corresponding one-hot codes; a mapping module 302 configured to input the one-hot codes corresponding to the text into
a token embedding layer, and perform mapping by using the token embedding layer to obtain a static token vector corresponding to each token;
an input module 303 configured to add the static token vector, a segment embedding vector, and a position embedding vector corresponding to each token to obtain a corresponding input vector of each token, and take the input vector as an input of the natural language pre-trained model to obtain a dynamic token vector corresponding to each token;
a calculating module 304 configured to calculate similarity between the static token vector and the dynamic token vector corresponding to each token, and take a similarity calculation result as a constraint item; and
an adjusting module 305 configured to adjust an original loss function of the natural language pre-trained model by using the constraint item, and train the natural language pre-trained model with the adjusted original loss function.

In some embodiments, the mapping module 302 of FIG. 3: generates a series of one-hot codes corresponding to the text based on the one-hot codes corresponding to the tokens in the text, inputs the series of one-hot codes into the token embedding layer, maps the series of one-hot codes by using the token embedding layer to obtain an original vector representation corresponding to each token, and takes the original vector representation of each token as the static token vector.

In some embodiments, the input module 303 of FIG. 3: acquires the segment embedding vector and the position embedding vector corresponding to each token in the text, maps the static token vector, the segment embedding vector, and the position embedding vector into a same dimensional space, and adds the static token vector, the segment embedding vector, and the position embedding vector in the same dimensional space to obtain the input vector corresponding to each token; and inputs the input vector into the natural language pre-trained model, performs training of a token masking task and a preceding-next sentence task by using the natural language pre-trained model, and outputs the dynamic token vector corresponding to each token in the text.

In some embodiments, the calculating module 304 of FIG. 3: calculates a vector inner product of the static token vector and the dynamic token vector of each token, takes the vector inner product as the similarity calculation result of the static token vector and the dynamic token vector, and takes the similarity calculation result as the constraint item constructed based on the static token vector; the static token vector and the dynamic token vector having a same dimension.

In some embodiments, the calculating module 304 of FIG. 3: calculates cosine similarity or a Manhattan distance between the static token vector and the dynamic token vector of each token, takes the cosine similarity or the Manhattan distance as the similarity calculation result of the static token vector and the dynamic token vector, and takes the similarity calculation result as the constraint item.

In some embodiments, the adjusting module 305 of FIG. 3 adjusts the original loss function using the following formula:

$$loss = ( 1 - α ) \cdot suploss - α \cdot regulation$$

wherein loss represent the adjusted loss unction, suploss represents the original loss function, α represents a partition coefficient and is used for adjusting model training precision, and regulation represents the constraint item constructed based on the static token vector.

It should be understood that, the sequence numbers of the steps in the foregoing embodiments do not imply an execution sequence, and the execution sequence of each process should be determined by functions and internal logic of the process, and should not constitute any limitation to the implementation process of the embodiments of the present application.

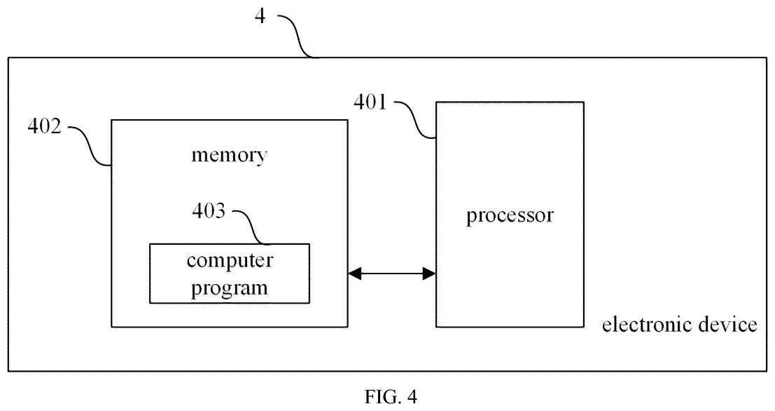

FIG. 4 is a schematic structural diagram of an electronic device 4 according to an embodiment of the present application. As shown in FIG. 4, the electronic device 4 according to the present embodiment includes: a processor 401, a memory 402, and a computer program 403 stored in the memory 402 and executable on the processor 401. The steps in the various method embodiments described above are implemented when the processor 401 executes the computer program 403. Alternatively, the processor 401 achieves the functions of each module/unit in each apparatus embodiment described above when executing the computer program 403.

Exemplarily, the computer program 403 may be partitioned into one or more modules/units, which are stored in the memory 402 and executed by the processor 401 to complete the present application. One or more of the modules/units may be a series of computer program instruction segments capable of performing specific functions, the instruction segments describing the execution of the computer program 403 in the electronic device 4.

The electronic device 4 may be a desktop computer, a notebook, a palm computer, a cloud server or another electronic device. The electronic device 4 may include, but is not limited to, the processor 401 and the memory 402. Those skilled in the art may understand that a structure shown in FIG. 4 is only an example of the electronic device 4 and does not limit the electronic device 4, which may include more or fewer components than those shown in the drawings, or some components may be combined, or a different component deployment may be used. For example, the electronic device may further include an input/output device, a network access device, a bus, or the like.

The processor 401 may be a Central Processing Unit (CPU), or other general-purpose processors, Digital Signal Processors (DSP), Application Specific Integrated Circuits (ASIC), Field-Programmable Gate Arrays (FPGA) or other programmable logic devices, discrete gates or transistor logic devices, discrete hardware components, etc. The general-purpose processor may be a microprocessor or the processor may be any general processor, or the like.

The memory 402 may be an internal storage unit of the electronic device 4, for example, a hard disk or memory of the electronic device 4. The memory 402 may also be an external storage device of the electronic device 4, such as a plug-in hard disk, a Smart Media Card (SMC), a Secure Digital (SD) Card, a Flash Card, or the like, configured on the electronic device 4. Further, the memory 402 may also include both the internal storage unit and the external storage device of the electronic device 4. The memory 402 is configured to store the computer program and other programs and data required by the electronic device. The memory 402 may be further configured to temporarily store data which has been or will be outputted.

It may be clearly understood by those skilled in the art that, for convenient and brief description, division of the above functional units and modules is used as an example for illustration. In practical application, the above functions can be allocated to different functional units and modules and implemented as required; that is, an internal structure of the apparatus is divided into different functional units or modules to accomplish all or some of the functions described above. The functional units or modules in the embodiments may be integrated into one processing unit, or each of the units may exist alone physically, or two or more units are integrated into one unit, and the integrated unit may be implemented in a form of hardware, or may also be implemented in a form of a software functional unit. In addition, specific names of all the functional units or modules are merely for facilitating the differentiation, but are not intended to limit the protection scope of this application. For a specific working process of the units or modules in the above system, reference may be made to the corresponding process in the foregoing method embodiments, which is not repeated herein.

In the above embodiments, the description of each embodiment has its own emphasis. For a part not described in detail in one embodiment, reference may be made to relevant description of other embodiments.

Those of ordinary skill in the art would appreciate that the units and algorithmic steps of the examples described in combination with the embodiments disclosed herein can be implemented by electronic hardware or a combination of computer software and electronic hardware. Whether these functions are performed by hardware or software depends on a specific application and design constraints of the technical solution. Technical professionals may achieve the described functions in different methods for each particular application, but such implementation should not be considered beyond the scope of the present application.

In the embodiments of the present application, it is to be understood that the disclosed apparatus/computer device and method can be implemented in other ways. For example, the embodiment of the apparatus/computer device described above is merely schematic. For example, the division of the modules or units is merely logical function division, and there may be other division manners in an actual implementation. For example, a plurality of units or components may be combined or integrated into another system, or some features may be ignored or not performed. In addition, the displayed or discussed mutual coupling or direct coupling or communication connection may be implemented by using some interfaces. The indirect coupling or communication connection between apparatuses or units may be implemented in an electric form, a mechanical form, or other forms.

The units described as separate parts may or may not be physically separate, and parts displayed as units may or may not be physical units, may be located at one position, or may be distributed on a plurality of network units. Some or all of the units may be selected according to actual needs to achieve the objectives of the solutions of the embodiments.

In addition, the functional units in the embodiments of the present application may be integrated into one processing unit, or each of the units may exist alone physically, or two or more units are integrated into one unit. The integrated unit may be implemented in a form of hardware or in a form of a software functional unit.

The integrated module/unit may be stored in a computer-readable storage medium when implemented in the form of the software functional unit and sold or used as a separate product. Based on such understanding, all or some of the processes in the method according to the above embodiments may be realized in the present application, or completed by the computer program instructing related hardware, the computer program may be stored in the computer-readable storage medium, and when the computer program is executed by the processor, the steps of the above method embodiments may be realized. The computer program may include a computer program code, which may be in a form of a source code, an object code or an executable file or in some intermediate forms. The computer-readable medium may include any entity or apparatus capable of carrying the computer program code, a recording medium, a USB flash drive, a removable hard disk, a magnetic disk, an optical disk, a computer memory, a Read-Only Memory (ROM), a Random Access Memory (RAM), an electrical carrier signal, a telecommunication signal, a software distribution medium, and so on. It should be noted that content included in the computer-readable medium may be appropriately increased or decreased according to requirements of legislation and patent practice in a jurisdiction, for example, in some jurisdictions, according to legislation and patent practice, the computer-readable medium does not include the electrical carrier signal and the telecommunication signal.

The above embodiments are merely intended to describe the technical solutions of the present application, but not to limit the present application. Although the present application is described in detail with reference to the foregoing embodiments, those of ordinary skill in the art should understand that they may still make modifications to the technical solutions described in the foregoing embodiments or make equivalent replacements to some technical features thereof. Such modifications or replacements do not cause the essence of the corresponding technical solutions to depart from the spirit and scope of the technical solutions of the embodiments of the present application, and should be included in the protection scope of the present application.

What is claimed is:

1. A method for training a natural language pre-trained model, comprising:
tokenizing a text by using a dictionary of the natural language pre-trained model, and converting tokens in the text into one-hot codes;
inputting the one-hot codes corresponding to the text into a token embedding layer, and performing mapping by using the token embedding layer to obtain a static token vector corresponding to each of the tokens;
adding the static token vector, a segment embedding vector, and a position embedding vector corresponding to each of the tokens to obtain a input vector of each of the tokens, and taking the input vector as an input of the natural language pre-trained model to obtain a dynamic token vector corresponding to each of the tokens;
calculating a similarity between the static token vector and the dynamic token vector corresponding to each of the tokens, and taking a similarity calculation result as a constraint item; and
adjusting an original loss function of the natural language pre-trained model by using the constraint item to obtain an adjusted original loss function, and training the natural language pre-trained model with the adjusted original loss function.

2. The method according to claim 1, wherein the step of inputting the one-hot codes corresponding to the text into the token embedding layer, and performing the mapping by using the token embedding layer to obtain the static token vector corresponding to each of the tokens comprises:
generating a series of one-hot codes corresponding to the text based on the one-hot codes corresponding to the tokens in the text, inputting the series of one-hot codes into the token embedding layer, mapping the series of one-hot codes by using the token embedding layer to obtain an original vector representation corresponding to each of the tokens, and taking the original vector representation of each of the tokens as the static token vector.

3. The method according to claim 1, wherein the step of adding the static token vector, the segment embedding vector, and the position embedding vector corresponding to each of the tokens to obtain the input vector of each of the tokens, and taking the input vector as the input of the natural language pre-trained model to obtain the dynamic token vector corresponding to each of the tokens comprises:
acquiring the segment embedding vector and the position embedding vector corresponding to each of the tokens in the text, mapping the static token vector, the segment embedding vector, and the position embedding vector into a same dimensional space, and adding the static token vector, the segment embedding vector, and the position embedding vector in the same dimensional space to obtain the input vector corresponding to each of the tokens; and
inputting the input vector into the natural language pre-trained model, performing training of a token masking task and a preceding-next sentence task by using the natural language pre-trained model, and outputting the dynamic token vector corresponding to each of the tokens in the text.

4. The method according to claim 1, wherein the step of calculating the similarity between the static token vector and the dynamic token vector corresponding to each of the tokens, and taking the similarity calculation result as the constraint item comprises:
calculating a vector inner product of the static token vector and the dynamic token vector of each of the tokens, taking the vector inner product as the similarity calculation result of the static token vector and the dynamic token vector, and taking the similarity calculation result as the constraint item constructed based on the static token vector; wherein the static token vector and the dynamic token vector a same dimension.

5. The method according to claim 1, wherein the step of calculating the similarity between the static token vector and the dynamic token vector corresponding to each of the tokens, and taking the similarity calculation result as the constraint item comprises:
calculating a cosine similarity or a Manhattan distance between the static token vector and the dynamic token vector of each of the tokens, taking the cosine similarity or the Manhattan distance as the similarity calculation result of the static token vector and the dynamic token vector, and taking the similarity calculation result as the constraint item.

6. The method according to claim 4, wherein the step of adjusting the original loss function of the natural language pre-trained model by using the constraint item comprises adjusting the original loss function using the following formula:
$$loss = ( 1 - α ) \cdot suploss - α \cdot regulation$$
wherein loss represent an adjusted loss function, suploss represents the original loss function, α represents a partition coefficient and is configured for adjusting a model training precision, and regulation represents the constraint item constructed based on the static token vector.

7. The method according to claim 1, wherein the natural language pre-trained model is a bidirectional encoder representation from transformers (BERT)-based self-attention pre-trained model.

8. An apparatus for training a natural language pre-trained model, comprising:
a converting module configured to tokenize a text by using a dictionary of the natural language pre-trained model, and convert tokens in the text into one-hot codes;
a mapping module configured to input the one-hot codes corresponding to the text into a token embedding layer, and perform mapping by using the token embedding layer to obtain a static token vector corresponding to each of the tokens;
an input module configured to add the static token vector, a segment embedding vector, and a position embedding vector corresponding to each of the tokens to obtain a input vector of each of the tokens, and take the input vector as an input of the natural language pre-trained model to obtain a dynamic token vector corresponding to each of the tokens;
a calculating module configured to calculate a similarity between the static token vector and the dynamic token vector corresponding to each of the tokens, and take a similarity calculation result as a constraint item; and
an adjusting module configured to adjust an original loss function of the natural language pre-trained model by using the constraint item to obtain an adjusted original loss function, and train the natural language pre-trained model with the adjusted original loss function.

9. An electronic device, comprising a memory, a processor, and a computer program stored on the memory and runnable on the processor, wherein the processor, when executing the computer program, implements the method according to claim 1.

10. A computer-readable storage medium storing a computer program, wherein the computer program, when executed by a processor, implements the method according to claim 1.
